(19) United States
(12) Patent Application Publication
(10) Pub. No.: US 2016/0212179 A1
(43) Pub. Date: Jul. 21, 2016

(54) METHODS AND APPARATUS FOR ESTABLISHING A CONNECTION IN A TELECOMMUNICATIONS NETWORK

(71) Applicant: TELEFONAKTIEBOLAGET L M ERICSSON (PUBL), Stockholm (SE)

(72) Inventors: Andras Kern, Budapest (HU); Balazs Peter Gero, Budapest (HU)

(21) Appl. No.: 14/912,600

(22) PCT Filed: Aug. 19, 2013
(86) PCT No.: PCT/EP2013/067234

§ 371 Date: Feb. 17, 2016

(51) Int. Cl. H04L 29/06

(52) U.S. Cl. CPC H04L 65/1069

(57) ABSTRACT

A first control plane entity (e.g. a client control plane entity) sends a first message to a second control plane entity (e.g. a server control plane entity) over the user to network interface using the path computation element communication protocol. The server control plane entity, on receiving the first message, may calculate a path for a connection and send a second message to the client control plane entity over the user to network interface using the path computation element communication protocol. The client and server control plane entities may then configure their respective networks of data plane nodes to establish the connection.

### TECHNICAL FIELD

This invention relates to a method and apparatus for establishing a connection in a telecommunications network.

### BACKGROUND

As a telecommunications network increases in size, it is typically separated into several interoperating control plane implementations to enhance the scalability of the network. Separate control plane entities communicate with each other through an interface. When two control plane entities are in a server/client relationship, this interface is known as a user to network (UNI) interface.

In General Multi-Protocol Label Switching (GMPLS) telecommunications networks, the UNI interface is defined as a “bidirectional signalling interface between service requester and service provide control plane instances” (see ITU-T G.8081). A widely used protocol for the GMPLS UNI is RSVP-TE, described in “Generalized Multiprotocol Label Switching (GMPLS) User-Network Interface (UNI): Resource ReserVation Protocol-Traffic Engineering (RSVP-TE) Support for the Overlay Model”, G. Swallow et al., IETF RFC 4208, October 2005. This document notes that no Interior Gateway Protocol (IGP) session is possible between two control plane entities, such that it is not possible to exchange information between the two control plane entities except the connection setup related attributes (which are communicated along with the connection setup). Thus, a client control plane entity has no information on the capabilities and available resources of the network of data plane nodes controlled by the server control plane entity (instead, it makes assumptions on the network model, e.g. it considers the network as an abstract node).

To address this problem, a routing protocol session between the two control plane entities allows the server control plane entity to disclose information about its capabilities and available resources. Various options for the server control plane entity to represent this information are discussed in “Framework and Requirements for Layer 1 Virtual Private Networks”, T. Takeda, IETF RFC4847, April 2007. However, due to confidentiality issues, the server control plane entity cannot disclose full and detailed information about its network of data plane nodes. This causes further issues, such as a UNI data link selection problem. For example, in the case of multi-homing, the client control plane entity does not have the required information for an optimal end-to-end connection among parallel UNI data links.

The server control plane entity has access to a path computation function (implemented by a Path Computation Element (PCE)). The architecture for this function is split, such that the

PCE is removed from the router and moved to a centralized control plane element. The protocol for communication between the PCE and the router (or any other path calculation client) is the Path Computation Element Communication Protocol (PCEP), described in “Path Computation Element (PCE) Communication Protocol (PCEP)” JP. Vasseur, J L. Le Roux, IETF RFC 5440, March 2009.

In order to establish a new connection in the telecommunications network, the client may send a path computation request (a PCEP message) to the PCE. The path computation request may originate from the client control plane entity or from its network of data plane nodes. The PCE receives the path computation request, calculates a path for the connection, and sends a path computation reply message indicating the path for the connection. These messages are directed through the UNI, such that the PCEP message (including the dependencies for the connection) is attached to the RSVP-TE message as it passes between the two control plane entities. This presents several problems. Firstly, the UNI must implement two protocols and procedures to translate the PCEP results into RSVP-TE signalling. Secondly, as there is a one-to-one relation between the RSVP-TE control sessions and the implemented connectivity services, the number of control sessions to be managed increases in proportion to the number of connection requests. Thirdly, as RSVP-TE is a soft-state protocol, periodic state updates are an additional burden on both the client and server control plane entities.

It is therefore desirable to alleviate some or all of the above problems.

### SUMMARY

According to a first aspect of the invention, there is provided a method for establishing a connection in a telecommunications network, the telecommunications network including a control plane entity controlling a plurality of data plane nodes, the method comprising the steps of: the control plane entity sending a first message to an external control plane entity over a user to network interface, the external control plane entity controlling a distinct plurality of data plane nodes; the control plane entity receiving a second message from the external control plane entity over the user to network interface, the second message indicating a path for a connection, wherein the control plane entity communicates with the external control plane entity over the user to network interface using a path computation element communication protocol.

According to a second aspect of the invention, there is provided a method for establishing a connection in a telecommunications network, the telecommunications network including a control plane entity controlling a plurality of data plane nodes, the method comprising the steps of: the control plane entity receiving a first message from an external control plane entity over a user to network interface, the external control plane entity controlling a distinct plurality of data plane nodes; the control plane entity calculating a path for a connection in response to receiving the first message; the control plane entity sending a second message to the external control plane entity over the user to network interface, the second message indicating the path for the connection, wherein the control plane entity communicates with the external control plane entity over the user to network interface using a path computation element communication protocol.

Using the methods of the present invention, a first control plane entity (e.g. a client control plane entity) may send a first message (such as a path computation request message) to a second control plane entity (e.g. a server control plane entity) over the user to network interface using the path computation element communication protocol. The server control plane entity, on receiving the first message, may calculate a path for a connection and send a second message (such as a path computation reply message) to the client control plane entity over the user to network interface using the path computation element communication protocol. The client and server control plane entities may then configure their respective networks of data plane nodes to establish the connection.

In the present invention, the control plane entities may communicate over the user to network interface using PCEP. PCEP may therefore be extended to take over the signalling functions of RSVP-TE over the UNI. This may solve several problems associated with RSVP-TE implemented UNIs. For example, RSVP-TE is a soft-state protocol (i.e. it requires periodic state updates) and necessitates a control session for each connection request. Accordingly, a PCEP implemented UNI is not soft-state such that the period state updated are not required, and only requires a single control session.

Furthermore, the UNI now only needs to implement a single protocol and there is no need for procedures to export and import data structures between the RSVP-TE and PCEP protocols. This therefore simplifies the connection setup process.

The server control plane entity may calculate a plurality of paths for the connection, the second message may indicate the plurality of paths for the connection, the client control plane entity may select a path from the plurality of paths and send a third message to the server control plane entity over the user to network interface, the third message indicating the path. Thus, the server control plane entity may report a plurality of suitable paths for the connection to the client control plane entity, and the client control plane entity may select the most suitable path and report this back to the server control plane entity. On receiving the third message from the client control plane entity, the server control plane entity may configure its network of data plane nodes according to the selected path.

The first message may include a first characteristic for the connection, the server control plane entity may calculate a plurality of paths for the connection, the second message may indicate a plurality of paths for the connection, and the client control plane entity may analyse the plurality of paths and send a third message to the server control plane entity over the user to network interface, the third message including a second characteristic for the connection, and the server control plane entity may calculate a revised plurality of paths for the connection in response to the third message, and send a fourth message to the client control plane entity over the user to network interface, the fourth message indicating the revised plurality of paths. Accordingly, the client control plane entity may initiate altered path calculation requests once it has analysed the initial plurality of paths from the server control plane entity. The altered path requests may include different characteristics for the connection, such as a different set of dependencies.

The client control plane entity may select a path from the revised plurality of paths, and send a fifth message to the server control plane entity over the user to network interface, the fifth message indicating the selected path. The client and server control plane entities may configure their respective networks of data plane nodes according to the selected path.

The client control plane entity may send a third message to the server control plane entity over the user to network interface, the server control plane entity may calculate a plurality of updated paths for the connection in response to receiving the third message, and send a fourth message to the client control plane entity over the user to network interface, the fourth message indicating the plurality of updated paths. Thus, after a connection has been established, the control plane entities may update the connection. This may be in response to the client control plane entity changing the attributes of the connections or the dependencies between them, such that an updated connection is desirable.

The client control plane entity may select a path from the plurality of updated paths, and may also initiate altered path calculation requests such that the server control plane entity calculates a revised plurality of updated paths. Once a path has been selected, the client and server control plane entities may establish the selected updated path. The messages may include a path computation request, path computation reply, path update, path computation create, and path state report messages.

A computer program product comprising computer executable code which when executed on a computer may cause the computer to control a node to perform the method of the first or second aspect of the invention.

According to a third aspect of the invention, there is provided a control plane device for a telecommunications network, the control plane device for controlling a plurality of data plane nodes and comprising a communications interface configured to send a first message to an external control plane entity over a user to network interface, the external control plane entity controlling a distinct plurality of data plane nodes, and configured to receive a second message from the external control plane entity over the user to network interface, the second message indicating a path for a connection; and a processor, wherein the processor is adapted to configure the plurality of data plane nodes according to the path, and the communications interface communicates with the external control plane entity over the user to network interface using a path computation element communication protocol.

According to a fourth aspect of the invention, there is provided a control plane device for a telecommunications network, the control plane device for controlling a plurality of data plane nodes and comprising a communications interface configured to receive a first message from an external control plane entity over a user to network interface, the external control plane entity controlling a distinct plurality of data plane nodes; and a processor adapted to calculate a path for a connection in response to receiving the first message and to configure the plurality of data plane nodes according to the path to establish the connection, wherein the communications interface is further configured to send a second message to the external control plane entity over the user to network interface, the second message indicating the path for the connection, and the communications interface communicates with the external control plane entity over the user to network interface using a path computation element communication protocol.

### BRIEF DESCRIPTION OF THE DRAWINGS

Embodiments of the invention will now be described, by way of example, and with reference to the drawings in which:

FIG. 1 is a schematic diagram of a telecommunications network including a client control plane entity and server control plane entity of an embodiment of the present invention, a plurality of server data plane nodes and a plurality of client data plane nodes;

FIGS. 2a and 2b are flow diagrams illustrating a first embodiment of a method of the present invention;

FIGS. 3a and 3b are flow diagrams illustrating a second embodiment of a method of the present invention;

FIGS. 4a and 4b are flow diagrams illustrating a third embodiment of a method of the present invention;

FIGS. 5a and 5b are flow diagrams illustrating a fourth embodiment of a method of the present invention;

FIGS. 6a and 6b are flow diagrams illustrating a fifth embodiment of a method of the present invention; and

FIGS. 7a and 7b are flow diagrams illustrating a fifth embodiment of a method of the present invention.

### DETAILED DESCRIPTION

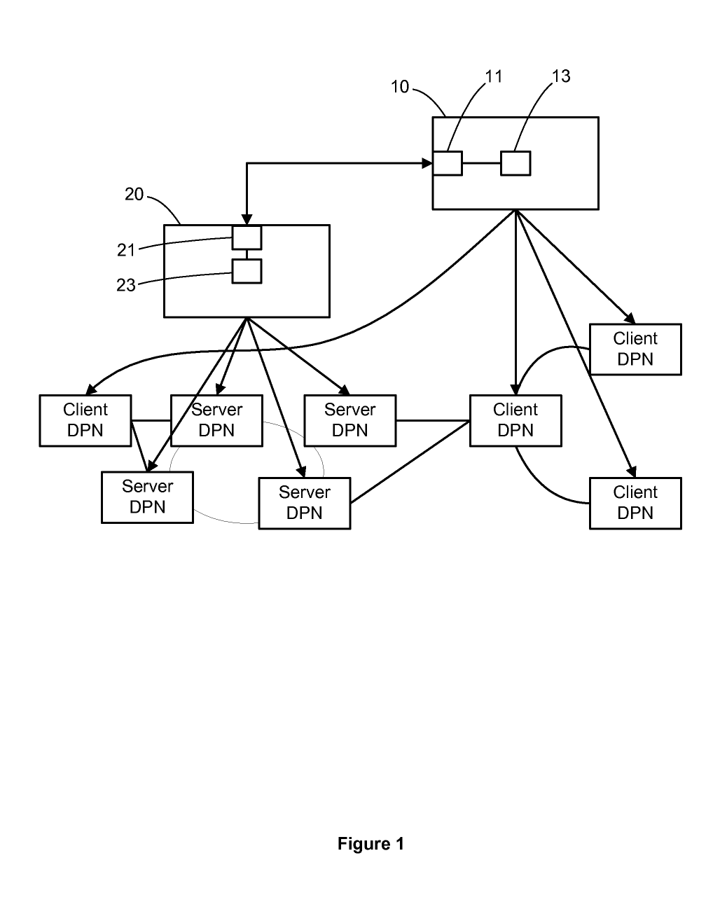

An embodiment of a telecommunications network of the present invention will now be described with reference to FIG. 1. The telecommunications network includes a first control plane entity 10 (hereinafter, the “client control plane entity”) and a second control plane entity 20 (hereinafter, the “server control plane entity”). The client control plane entity is configured to control a plurality of client data plane nodes, and the server control plane entity is configured to control a plurality of server data plane nodes.

The client control plane entity 10 and server control plane entity 20 both include respective communications interfaces 21, 23, which are configured to communicate with each other over a user to network interface (UNI) using the path computation element communication protocol (PCEP). In this embodiment, there is a single user to network interface and the telecommunications network supports GMPLS.

The client control plane entity 10 and server control plane entity 20 both include processors 13, 23. The processors 13, 23 are configured to carry out the steps of the embodiments of the method of the present invention in order to establish a connection, which will now be described in more detail.

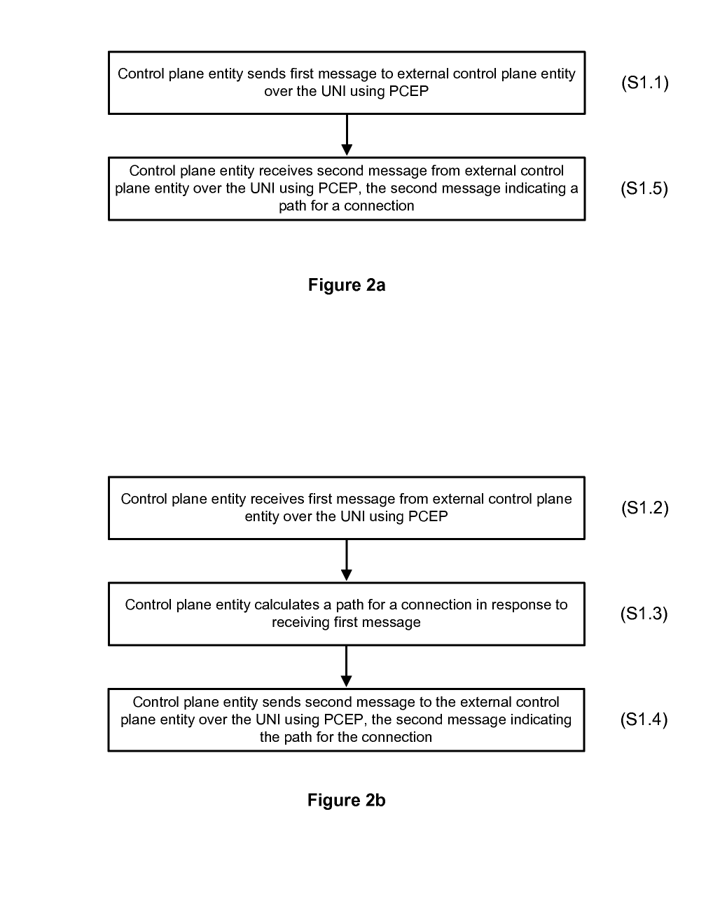

A first embodiment of a method of the present invention will now be described with reference to FIGS. 2a and 2b, wherein FIG. 2a illustrates the steps implemented by the client control plane entity and FIG. 2b illustrates the steps implemented by the server control plane entity. In this embodiment, the control plane entity 10 sends a first message (such as a path computation request message) to the server control plane entity 20 over the UNI interface using PCEP (step S1.1). The server control plane entity 20 receives the first message (step S1.2), calculates a path for a connection (step S1.3), and sends a second message to the client control plane entity 10 via the UNI using PCEP, the second message indicating the path for the connection (step S1.4).

The client control plane entity 10 receives the second message from the server control plane entity 20 (step S1.5), the second message indicating the path for the connection. The server and client control plane entities may therefore configure their respective networks of data plane nodes to establish the connection.

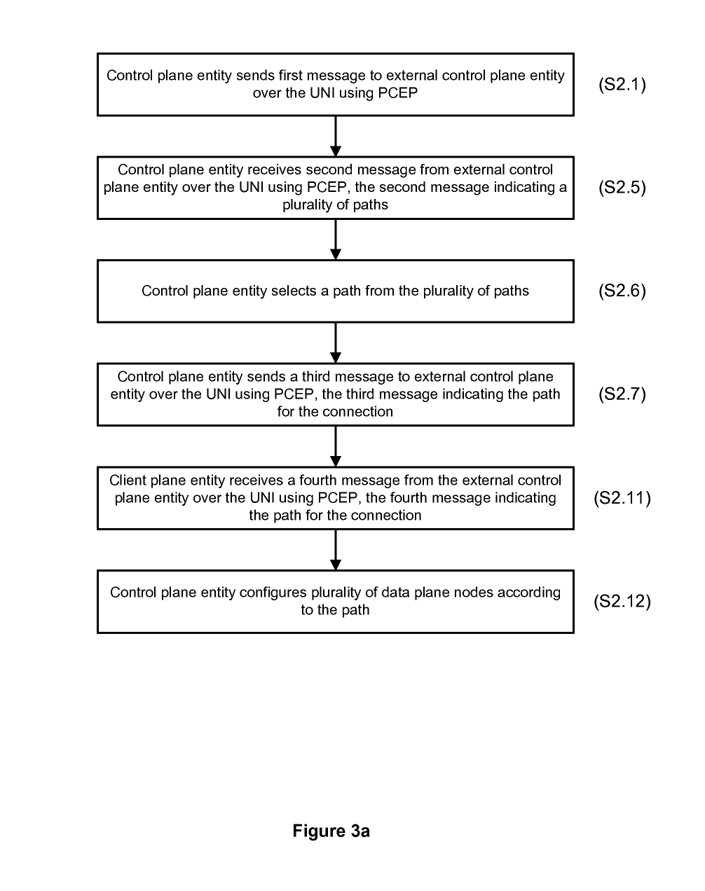

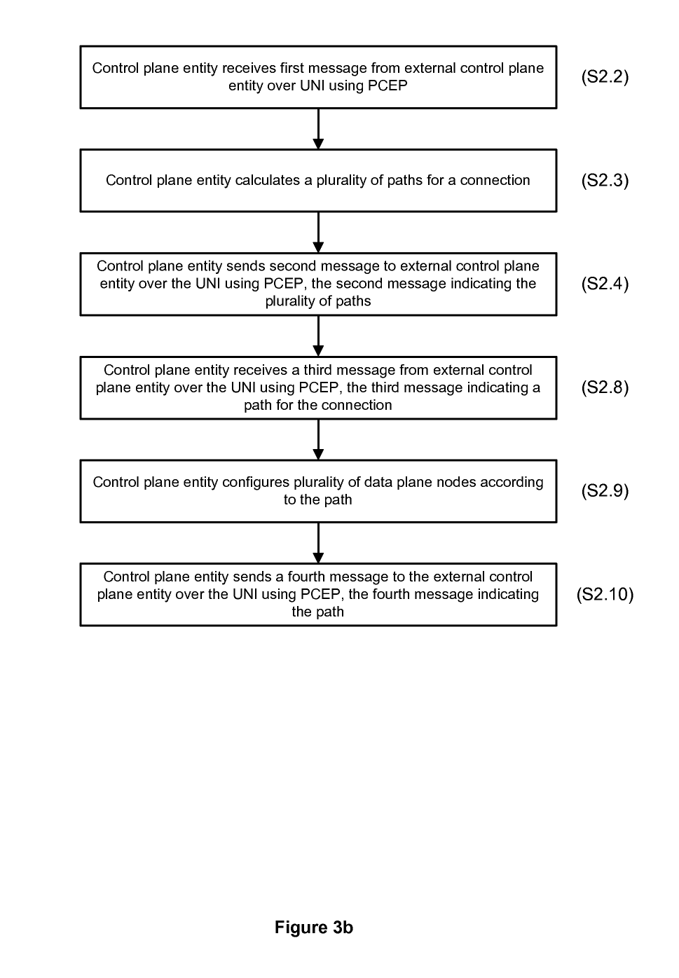

A second embodiment of a method of the present invention will now be described with reference to FIGS. 3a and 3b, wherein FIG. 3a illustrates the steps implemented by the client control plane entity and FIG. 3b illustrates the steps implemented by the server control plane entity. The client control plane entity 10 sends a path computation request message to the server control plane entity 20 over the UNI using PCEP (step S2.1). The path computation request message specifies a number of characteristics for a connection (such as an attribute or dependency) which are described using synchronization vectors (described in more detail below). The skilled person will understand that the path computation request message may request a path for several connections. However, for simplicity, only one connection will be described.

The server control plane entity 10 receives the path computation request message (step S2.2), and in response, calculates a plurality of paths for the connection that fulfils the given characteristics (step S2.3). In this embodiment, the server control plane entity 20 includes a path computation element to calculate the path for the connection locally.

In this embodiment (which may be known as a “two-phase implementation”), the server control plane entity 20 sends a path computation reply message to the client control plane entity 10 over the UNI using PCEP (step S2.4). The path computation reply message indicates the plurality of paths for the connection and specifies all connectivity attributes required for the client control plane entity 10 to set up the connection. The client control plane entity 10 receives the path computation reply message (step S2.5), selects a path from the plurality of paths (step S2.6), and sends a path computation create message to the server control plane entity over the UNI using PCEP (step S2.7). The path computation create message requests the server control plane entity 20 to deploy the connection along the path, and carries a connection descriptor together with the selected path (or reference to the path via path keys).

The server control plane entity 20 receives the path computation create message (step S2.8) and configures the server data plane nodes according to the selected path to establish the connection (step S2.9). As part of this configuration, the server control plane entity 20 may instantiate the connection or a segment of the connection between the server data plane nodes facing the client data plane nodes. This connection (or segment) can be exclusively associated to the requested end-to-end tunnel or can carry a multiplicity of client connections. Furthermore, the server control plane entity 20 may configure the client data plane nodes facing the server data plane nodes to map the end-to-end connection either to nest end-to-end connection into or stitch it to an aggregation connection. The server control plane entity 20 sends a path state report message to the client control plane entity 10 (step S2.10) once the server data plane nodes are configured to carry the end-to-end connection between the client data plane nodes. The path state report message includes a delegation flag indicating that the client control plane entity 10 will own the requested connection and an operation flag indicating that the connection is operational.

On receiving the path state report message (step S2.11), the client control plane entity 10 may determine that the requested connection is ready to be used. Accordingly, the client control plane entity 10 then configures the client data plane nodes according to the selected path to establish the connection (step S2.12). In the event the client control plane entity 10 has requested multiple connections, it may wait for the path state report message to indicate that all the requested connections have been configured on the server data plane nodes before it configures the client data plane nodes.

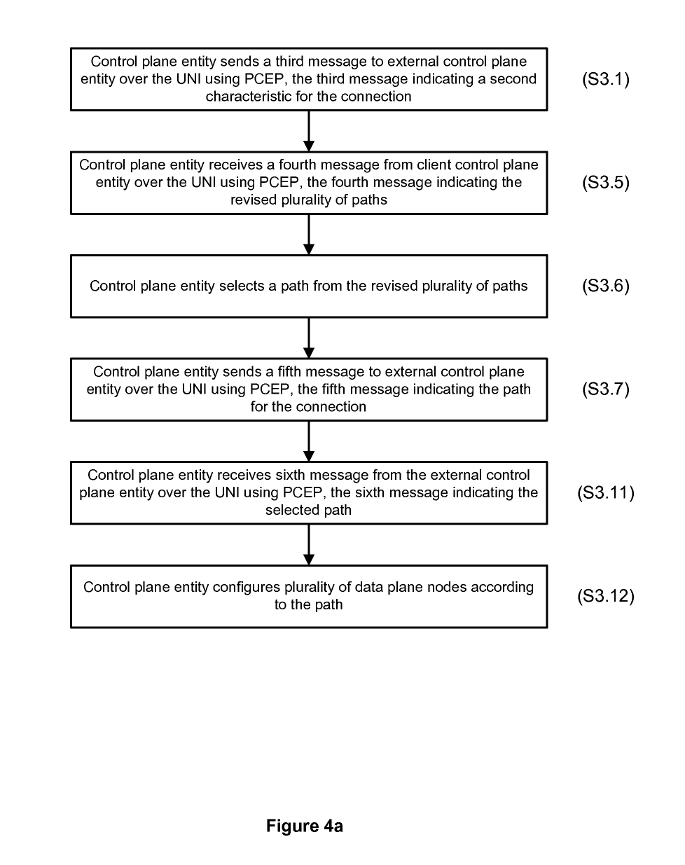

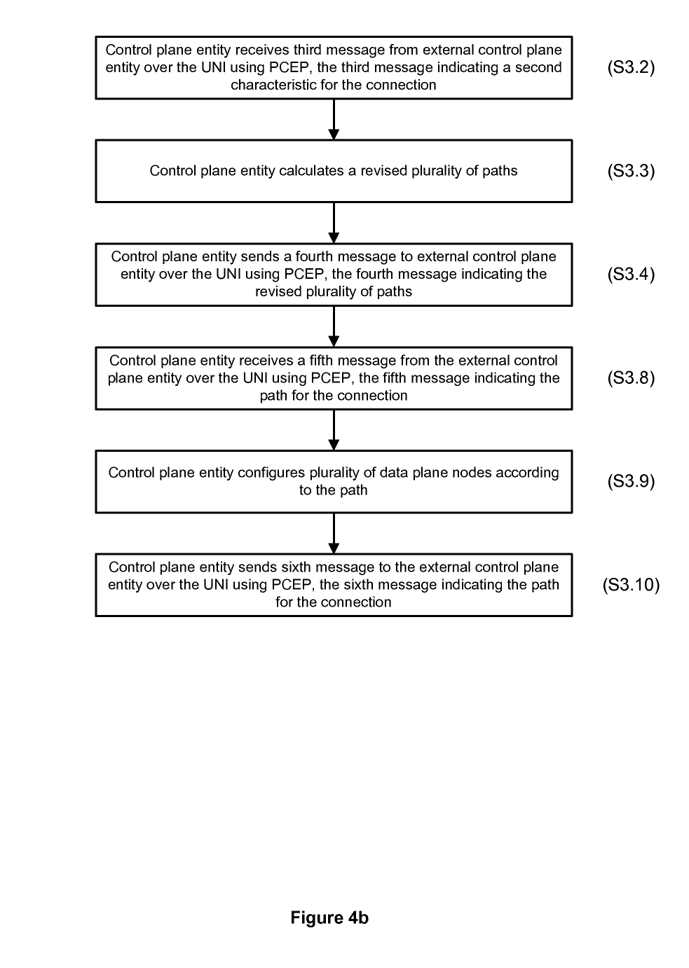

A third embodiment of a method according to the present invention will now be described with reference to FIGS. 4a and 4b, wherein FIG. 4a illustrates the steps implemented by the client control plane entity and FIG. 4b illustrates the steps implemented by the server control plane entity. This embodiment includes steps similar to steps S2.1 to S2.5 inclusive from the second embodiment, such that the client control plane entity 10 receives a path computation reply message indicating a plurality of paths for the connection. However, at this point, the client control plane entity 10 initiates an altered path calculation request. Accordingly, the client control plane entity 10 sends a new path computation request message to the server control plane entity 20 over the UNI using PCEP (step S3.1). The new path computation request message indicates a new characteristic for the connection (e.g. a new dependency for the connection), described by synchronization vectors.

On receipt of the new path computation request message (step S3.2), the server control plane entity 20 calculates a revised plurality of paths for the connection (step S3.3), and sends a path computation reply message to the client control plane entity 10 over the UNI using PCEP (step S3.4), indicating the revised plurality of paths and including the connectivity attributes required for the client control plane entity 10 to set up the connection.

The client control plane entity 10 receives the path computation reply message (step S3.5) may continue to initiate altered path computation requests, until it selects a path from the revised plurality of paths (step S3.6). The client control plane entity 10 then sends a path computation create message to the server control plane entity 20 over the UNI using PCEP (step S3.7), the path computation create message indicating the selected path. The server control plane entity 20 receives the path computation create message (step S3.8), configures the server data plane nodes (step S3.9) and sends a path state report message to the client control plane entity 10 over the UNI using PCEP (step S3.10). The client control plane entity 10 receives the path state report message (step S3.11), and configures the client data plane nodes (step S3.12) in a similar manner as described in the first embodiment of the method of the present invention.

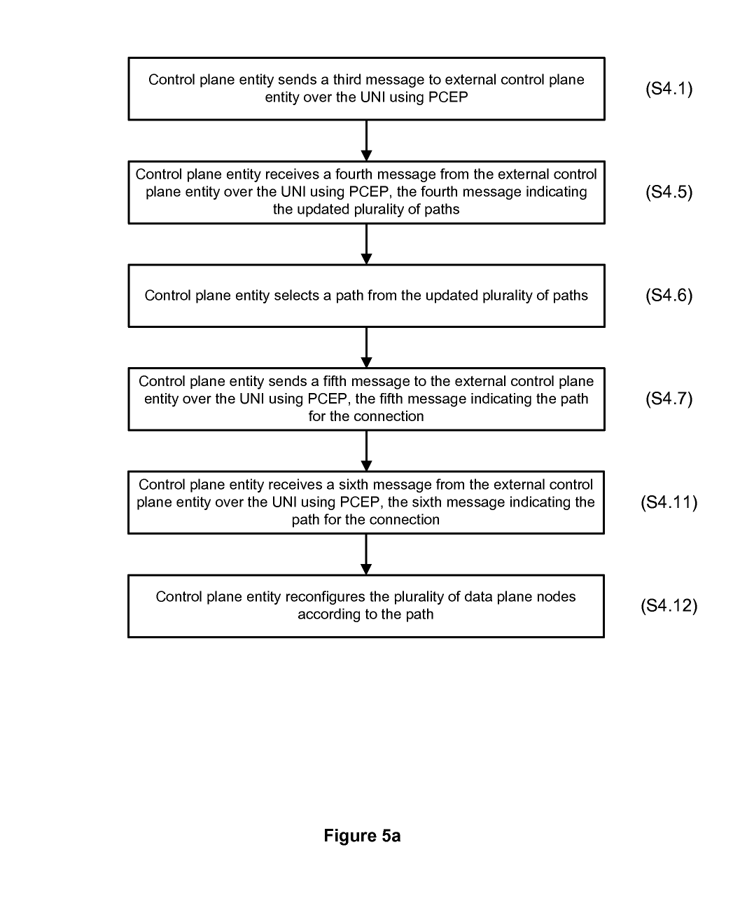

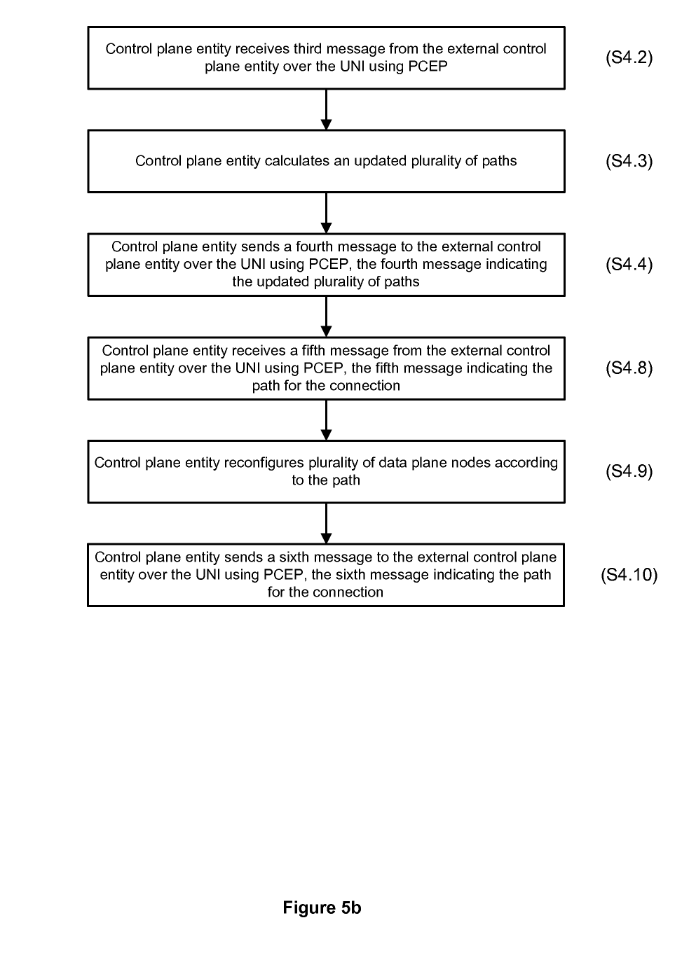

A fourth embodiment of a method according to the present invention will now be described with reference to FIGS. 5a and 5b, wherein FIG. 5a illustrates the steps implemented by the client control plane entity and FIG. 5b illustrates the steps implemented by the server control plane entity. This embodiment includes steps similar to steps S2.1 to S2.12 from the second embodiment of the present invention, such that the client and server control plane entities have established the connection on the client and server data plane nodes respectively. However, in this embodiment, the client control plane entity 10 subsequently updates the connection. This may occur, for example, as the client control plane entity changes the attributes of the connection or the dependencies between connections.

In this embodiment, the client control plane entity 10 determines one or more connections which need to be changed, and sends a updated path computation request message to the server control plane entity 20 over the UNI using PCEP (step S4.1). The updated path computation request message indicates an updated set of characteristics (e.g. attributes, dependencies) for the one or more connections. For simplicity, the case of a single connection being updated will be described.

The server control plane entity 20 receives the updated path computation message (step S4.2), calculates an updated plurality of paths (step S4.3), and sends a path computation reply message to the client control plane entity 10 over the UNI using PCEP (step S4.4), the path computation reply message indicating the updated plurality of paths.

In this embodiment, the client control plane entity 10 receives the path computation reply message (step S4.5), selects a path from the updated plurality of paths (step S4.6) and sends a path update message to the server control plane entity 20 over the UNI using PCEP (step S4.7), the path update message indicating the selected path using connection descriptors together with the selected path.

The server control plane entity 20 receives the path update message (step S4.8), reconfigures the server data plane nodes according to the selected path in response to receiving the path update message (step S4.9), and (in a similar manner to steps 2.11 and 2.12 of the first embodiment of the method) sends a path state report message to the client control plane entity 10 which reconfigures the client data plane nodes (in steps S4.10-4.12)

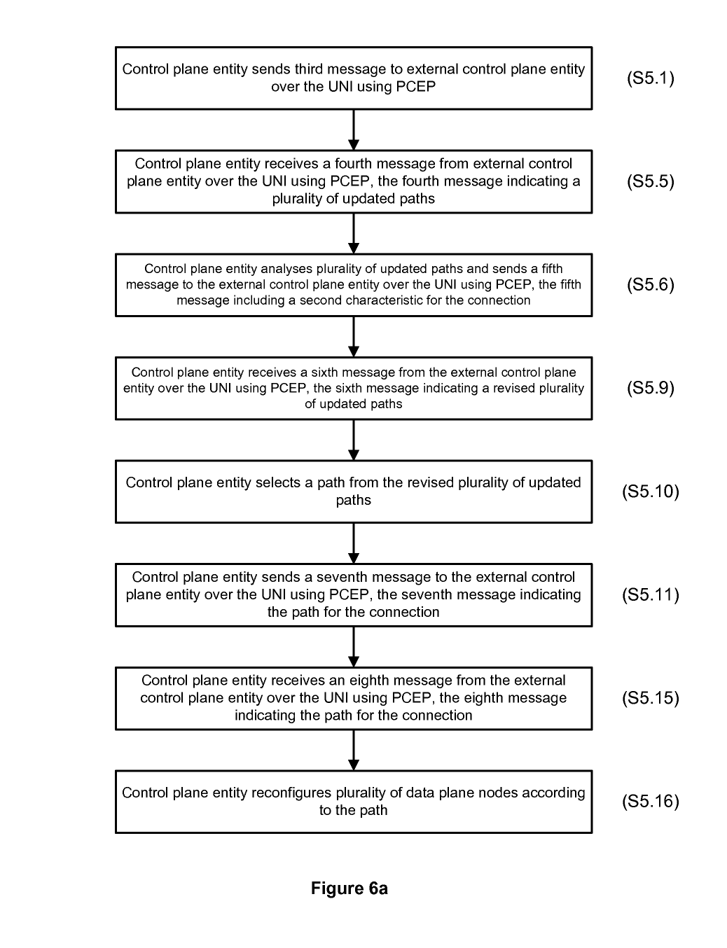

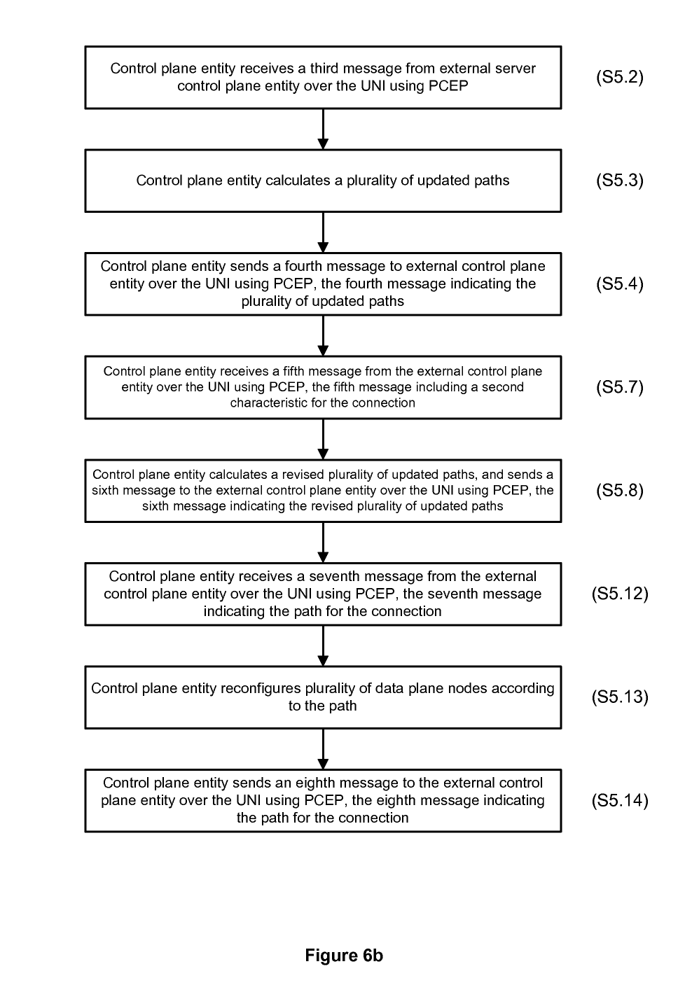

A fifth embodiment of a method of the present invention will now be described with reference to FIGS. 6a and 6b, wherein FIG. 6a illustrates the steps implemented by the client control plane entity and FIG. 6b illustrates the steps implemented by the server control plane entity. The fourth embodiment also includes steps similar to steps S2.1 to S2.12 from the second embodiment, and includes steps similar to S4.1 to 4.5 from the fourth embodiment (now steps 5.1 to 5.5 in this embodiment). However, at this point, the client control plane entity 10 initiates an altered path computation request.

Accordingly, the client control plane entity 10 sends a new updated path computation request message to the server control plane entity 20 over the UNI using PCEP (step S5.6), the new updated path computation request message specifying a new characteristic for the updated connection. The server control plane entity 20 receives the new path computation request message (step S5.7), calculates a revised plurality of updated paths and sends a new path computation report message to the client control plane entity 10 over the UNI using PCEP indicating the revised plurality of updated paths (step S5.8).

The client control plane entity 10 receives the path computation report message (step 5.9) and may continue to initiate altered path computation requests until it selects a path from the revised plurality of updated paths (step S5.10). The client control plane entity 10 then sends a path update message to the server control plane entity 20 indicating the selected path (step S5.11). The server control plane entity receives the path update message (step 5.12), reconfigures the server data plane nodes according to the selected path (step S5.13) and sends a path state report message to the client control plane entity 10 (step S5.14). The client control plane entity 10 receives the path state report message (step S5.15) and reconfigures the client data plane nodes according to the selected path (step S5.16).

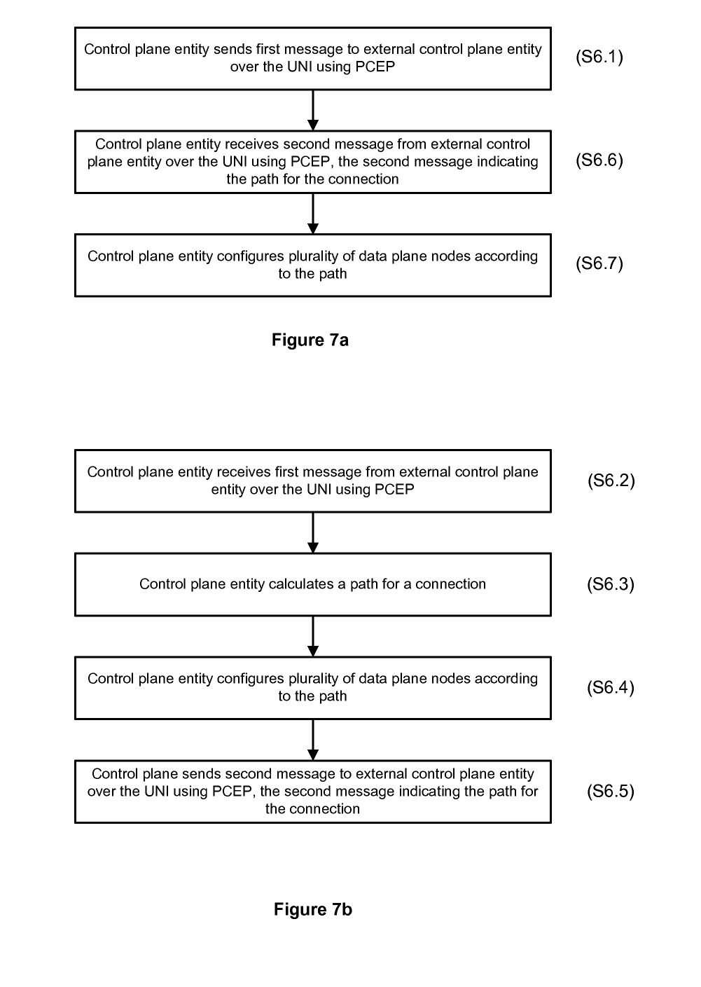

A sixth embodiment of a method of the present invention will now be described with reference to FIGS. 7a and 7b, wherein FIG. 7a illustrates the steps implemented by the client control plane entity and FIG. 7b illustrates the steps implemented by the server control plane entity. In this embodiment, the client control plane entity 10 sends a first message to the server control plane entity 20 over the UNI using PCEP (step S6.1). The first message indicates a plurality of connection requests and includes the dependences between each requested connection in an extended version of the path computation request message (“PCCreateSync”, described in more detail below).

The server control plane entity 10 receives the extended path computation request message (step S6.2), and in response, calculates a set of paths for the requested connections that fulfil the given characteristics (step S6.3). In this embodiment (which may be known as a “one-phase implementation”), the server control plane entity 20 configures the server data plane nodes to establish the requested connections (step S6.4)

The server control plane entity 20 sends a path state report message to the client control plane entity 10 over the UNI using PCEP, which includes all the connectivity attributes required for the client control plane entity 10 to set up the requested connections on the client data plane nodes (step S6.5). The client control plane entity 10 receives the path state report message (step S6.6) and configures the client data plane nodes accordingly to establish the requested connections (step S6.7).

The one-phase implementation may also update an existing connection using an extended version of the path update message (“PCUpdSync”, described in more detail below), in order to update an existing connection with new characteristics.

The extended path computation request message (“PCCreateSync”) will now be described in more detail. The PCCreateSync message expresses the dependencies between the LSP instantiation requests using Synchronization Vectors (SVEC). A list of SVEC elements are included in the header of the PCCreateSync message, and the details of the requested connections are listed in an “Isp instantiation list”. An example PCCreateSync message is shown below.

| | | |
|---|---|---|
| <PCCreateSync Message> | ::= | <Common Header> |
| | | [<svec-list>] |
| | | <Isp-instantiation-list> |
| <Isp-instantiation-list> | ::= | <Isp-instantiation-request-ext> |
| | | [<Isp-instantiation-list>] |

In order to specify the details of the LSPs to be created, a series of objects are used. The requests start with an “RP” object (see RFC5440). The RP object defines an identifier for the connection which is used in the SVEC objects as a reference to the LSP instance. The source and destination nodes of a connection are specified via the “END-POINTS” object. An example is shown below,

| | | |
|---|---|---|
| <Isp-instantiation-request-ext> | ::= | <RP> |
| | | <END-POINTS> |
| | | [<ERO>] |
| | | [<BANDWIDTH>] |
| | | [<metric-list>] |

The flags of the RP object may be adapted as follows:
The priority field can be used as described in RFC5440;
The strict/loose flag is set to 1 since the server control plane entity 20 may apply local policies on the path(s) reported to the client control plane entity 10. In some cases, when the client sets this flag to 0, the server control plane entity 20 may either refuse the creation of the path(s) or can make use of the path key set;
Reoptimization flag is set to 0, since the PCCreateSync message always indicates the request of a new connection. Requests with reoptimization flag set to 1 will be refused by the server control plane entity and generate an error message;
The bidirectional flag may be set to 1 to indicate that the LSP to be instantiated is a co-routed bidirectional LSP, or set to 0 to indicate a unidirectional LSP.

The extended path update message (“PCUpdSync”) will now be described in more detail. In the one-phase implementation above, the client control plane entity 10 may update all attributes with the connections using the PCUpdSync message, wherein the dependencies are encoded in the message using a series of Synchronization Vector (SVEC) objects.

The update method of these attributes is soft-state. That is, by omitting an attribute or dependency descriptor in an update message, the server control plane entity 10 will not take the omitted attributes into account any longer. However, if the SVEC objects specifies new dependencies or attributes, the server control plane entity will re-evaluate the connection taking into account the new characteristics. If the server control plane entity 10 cannot update the requested connections affected by the new characteristics, the connection will be torn down.

An example PCUpdSync message is shown below.

| | | |
|---|---|---|
| <PCUpdSync Message> | ::= | <Common Header> |
| | | [<svec-list>] |
| | | <Isp-update-list> |
| <Isp-update-list> | ::= | <Isp-update-request-ext> |
| | | [<Isp-update-list>] |

In order to specify the details of the LSPs to be updated, a series of objects are used. In this example, the request uses an RP object (as detailed in RFC 5440), which defines an identifier for the LSP, which is used in the SVEC objects as a reference for the LSP instance. The remainder of the LSP attributes are encoded as described in “PCEP Extensions for Stateful PCE”, E. Crabbe et al., IETF CCAMP WG draft, 22 Mar. 2013. An example message is shown below.

| | | |
|---|---|---|
| <Isp-update-request-ext> | ::= | <RP> |
| | | <LSP> |
| | | [<path-list>] |

The flags of the RP object are adapted for the PCUpdSync message such that the priority and strict/loose flags are set to 0 and the reoptimization flag is set to 1. Again, the bidirectional flag may be set to 1 to indicate that the LSP to be instantiated is a co-routed bidirectional LSP, or set to 0 to indicate a unidirectional LSP.

The path state report message may also be extended. “PCEP Extensions for PCE-initiated LSP Setup in a Stateful PCE Model”, E. Crabbe et al., IETF individual draft, 9 Oct. 2012, includes procedures for the requested connections to be delegated to the client control plane entity, such that it has the right to alter attributes of the connection in subsequent update messages. The server control plane entity informs the client control plane entity of the configured incoming and outgoing interfaces by including optional “END-POINTS” or via the “ERO” object.

Methods for addressing the data plane nodes will now be discussed. In the above embodiments, the server and client control plane nodes configure their respective data plane nodes according to a path to establish a connection. This is achieved by reusing the GMPLS UNI node addressing scheme (see Section 2 of RFC 4208). In particular:
The client control plane entity requests connections between client data plane nodes, and the addresses of the source and destination client data plane nodes are encoded in the “END-POINTS” object of the message;
The server control plane entity is aware to the client data plane node address (as discussed in RFC 4208) and is able to determine the appropriate server data plane nodes, which face the source and destination client data plane nodes, respectively;
The server control plane entity selects a link from a set of links between client and server data plane nodes. The selected link is encoded in the “ERO” object of the path computation reply and path state report messages;
The client control plane entity also selects a link between the client and server data plane nodes (UNI data link) and may encode the selected link in the “IRO” object of the path computation request message or the “ERO” object of the extended path computation create message. For example, the first ERO object identifies the source side UNI link and the last ERO object identifies the destination side UNI link (zero or more ERO objects encode hints on the request route). Then, the server control plane entity will return an error message if it cannot calculate a connection which runs through the links selected by the client control plane entity. Alternatively, the client control plane entity may address the UNI data links by including their addresses into END-POINTS objects instead of the client data plane node's own address. However, in this case, the link addresses to be used are considered in the point of view of client data plane node.

Connection ownership will now be discussed in more detail. In the embodiments of the method described above the server control plane entity configures the server data plane nodes and does not have access to the client data plane nodes. The client data plane nodes are configured by the client control plane entity, which does not have access to the server data plane nodes. The control state to manage the requested connection is split between the client and server control plane entities, but the client control plane entity owns the connection itself. This implies the following rules:
Shared Ownership: When the connection between the server data plane nodes is established and the client data plane node facing ports of the server data plane nodes has been configured, the server control plane entity passes the ownership of the connection to the client control plane entity as part of the delegation process. The delegation is only applicable to those attributes (such as the details of the link between adjacent server and client data plane nodes, or the capacity reserved for the connection). These delegated attributes cannot be changed by the server control plane entity. However, there may be additional attributes of the connection, which are local to the server control plane entity and are not reported to the client control plane entity, which the server control plane entity has the right to change.
The client control plane entity may return the delegation, such that it no longer controls the connection. The server control plane entity may remove or keep the established connection.

The skilled person will understand that the control plane entities do not need to be based on a single network element, but may have a distributed architecture. For example, the server control plane entity described above includes the PCE. However, it may be based in a separate element. Furthermore, the skilled person will also understand that the messages described above may originate from either the control plane entities or any other element in its network.

The skilled person will also understand that the invention is not limited to the specific types of messages described in each embodiment (such as a path computation request message, path computation reply message, etc.). Rather, the messages are part of a PCEP implemented UNI, and may take any form suitable for PCEP now or in the future.

The skilled person will also understand that the present invention applies to establishing a single connection in a telecommunications network or a set of connections in a telecommunications network. That is, the client control plane entity may send a path computation request message indicating a set of connections (each having a set of dependencies), and the server control plane entity may calculate a path or plurality of paths for each connection of the set of connections. When the client and server control plane entities configure their respective data plane nodes, they may then configure the data plane nodes to establish the set of connections.

The skilled person will understand that any combination of features is possible within the scope of the invention, as claimed.

1. A method for establishing a connection in a telecommunications network, the telecommunications network including a control plane entity controlling a plurality of data plane nodes, the method comprising the steps of:
the control plane entity sending a first message to an external control plane entity over a user to network interface, the external control plane entity controlling a distinct plurality of data plane nodes;
the control plane entity receiving a second message from the external control plane entity over the user to network interface, the second message indicating a path for a connection,
wherein the control plane entity communicates with the external control plane entity over the user to network interface using a path computation element communication protocol.

2. (canceled)

3. A method as claimed in claim 1, wherein the second message indicates a plurality of paths for the connection, the method further comprising the steps of:
the control plane entity selecting a path from the plurality of paths, and sending a third message to the external control plane entity over the user to network interface, the third message indicating the path.

4. A method as claimed in claim 3, wherein the first message is a path computation request message, the second message is a path computation reply message and the third message is a path create request message.

5. A method as claimed in claim 4, wherein the path computation request message specifies a dependency for the connection with synchronization vectors.

6-7. (canceled)

8. A method as claimed in claim 1, wherein the first message includes a first characteristic for the connection and the second message indicates a plurality of paths for the connection, the method further comprising the steps of:
the control plane entity analysing the plurality of paths;
the control plane entity sending a third message to the external control plane entity over the user to network interface, the third message including a second characteristic for the connection;
the control plane entity receiving a fourth message from the external control plane entity over the user to network interface, the fourth message indicating a revised plurality of paths for the connection; and
the control plane entity selecting a path from the revised plurality of paths sending a fifth message to the external control plane entity over the user to network interface, the fifth message indicating the selected path; and
the control plane entity receiving a sixth message from the external control plane entity over the user to network interface, the sixth message indicating the selected path.

9. A method as claimed in claim 8, wherein the first and third messages are path computation request messages, the second and fourth messages are path computation reply messages, and the fifth message is a path create request message.

10. (canceled)

11. A method as claimed in claim 1, further comprising the step of:
the control plane entity configuring the plurality of data plane nodes according to the path to establish the connection.

12. A method as claimed in claim 1, further comprising the steps of:
the control plane entity sending a third message to the external control plane entity over the user to network interface; and
the control plane entity receiving a fourth message from the external control plane entity over the user to network interface, the fourth message indicating a plurality of updated paths for the connection.

13. A method as claimed in claim 12, further comprising the steps of:
the control plane entity selecting a path from the plurality of updated paths, and sending a fifth message to the external control plane entity over the user to network interface, wherein the fifth message indicates the path for the connection; and
the control plane entity receiving a sixth message from the external control plane entity over the user to network interface, the sixth message indicating the path for the connection.

14-16. (canceled)

17. A method as claimed in claim 12, wherein the third message includes a first characteristic for the connection, the method further comprising the steps of:
the control plane entity analysing the plurality of updated paths;
the control plane entity sending a fifth message to the external control plane entity over the user to network interface, the fifth message including a second characteristic for the connection;
the control plane entity receiving a sixth message from the external control plane entity over the user to network interface, the sixth message indicating a revised plurality of updated paths for the connection;
the control plane entity selecting a path from the revised plurality of updated paths, and sending a seventh message to the external control plane entity over the user to network interface, the seventh message indicating the path for the connection; and
the control plane entity receiving an eighth message from the external control plane entity over the user to network interface, the eighth message indicating the path for the connection.

18-20. (canceled)

21. A control plane device for a telecommunications network, the control plane device for controlling a plurality of data plane nodes and comprising:
a communications interface configured to send a first message to an external control plane entity over a user to network interface, the external control plane entity controlling a distinct plurality of data plane nodes, and configured to receive a second message from the external control plane entity over the user to network interface, the second message indicating a path for a connection; and
a processor,
wherein the processor is adapted to configure the plurality of data plane nodes according to the path, and the communications interface communicates with the external control plane entity over the user to network interface using a path computation element communication protocol.

22. (canceled)

23. A method for establishing a connection in a telecommunications network, the telecommunications network including a control plane entity controlling a plurality of data plane nodes, the method comprising the steps of:
the control plane entity receiving a first message from an external control plane entity over a user to network interface, the external control plane entity controlling a distinct plurality of data plane nodes;
the control plane entity calculating a path for a connection in response to receiving the first message;
the control plane entity sending a second message to the external control plane entity over the user to network interface, the second message indicating the path for the connection,
wherein the control plane entity communicates with the external control plane entity over the user to network interface using a path computation element communication protocol.

24. (canceled)

25. A method as claimed in claim 23, wherein the control plane entity calculates a plurality of paths for the connection, the method further comprising the steps of:
the control plane entity receiving a third message from the external control plane entity over the user to network interface, the third message indicating a path from the plurality of paths.

26.-29. (canceled)

30. A method as claimed in claim 23, wherein the first message includes a first characteristic for the connection, the control plane entity calculates a plurality of paths for the connection and the second message includes the plurality of paths, the method further comprising the steps of:
the control plane entity receiving a third message from the external control plane entity over the user to network interface, the third message including a second characteristic for the connection;
the control plane entity calculating a revised plurality of paths for the connection in response to the third message, and sending a fourth message to the external control plane entity over the user to network interface, the fourth message indicating the revised plurality of paths for the connection
the control plane entity receiving a fifth message from the external control plane entity over the user to network interface, the fifth message indicating a path for the connection; and
the control plane entity sending a sixth message to the external control plane entity over the user to network interface, the sixth message indicating the path for the connection.

31. A method as claimed in claim 23, further comprising the step of:
the control plane entity configuring the plurality of data plane nodes according to the path to establish the connection.

32. A method as claimed in either claim 30, wherein the first and third messages are path computation request messages, the second and fourth messages are path computation reply messages, and the fifth message is a path create request message.

33. (canceled)

34. A method as claimed in claim 23, further comprising the steps of:
the control plane entity receiving a third message from the external control plane entity over the user to network interface);
the control plane entity calculating a plurality of updated paths for the connection in response to the third message, and sending a fourth message to the external control plane entity over the user to network interface, the fourth message indicating the plurality of updated paths.

35. A method as claimed in claim 34, further comprising the steps of:
the control plane entity receiving a fifth message from the external control plane entity over the user to network interface, the fifth message indicating a path for the connection; and
the control plane entity sending a sixth message to the external control plane entity over the user to network interface, the sixth message indicating the path for the connection.

36.-38. (canceled)

39. A method as claimed in claim 34, wherein the third message includes a first characteristic for the connection, the method further comprising the steps of:
the control plane entity receiving a fifth message from the external control plane entity over the user to network interface, the fifth message including a second characteristic for the connection;
the control plane entity calculating a revised plurality of updated paths for the connection in response to the fifth message, and sending a sixth message to the external control plane entity over the user to network interface, the sixth message indicating the revised plurality of updated paths for the connection;
the control plane entity receiving a seventh message from the external control plane entity over the user to network interface, the seventh message indicating a path for the connection; and
the control plane entity sending an eighth message to the external control plane entity over the user to network interface, the eighth message indicating the path for the connection.

40.-43. (canceled)

44. A control plane device for a telecommunications network, the control plane device for controlling a plurality of data plane nodes and comprising:
a communications interface configured to receive a first message from an external control plane entity over a user to network interface, the external control plane entity controlling a distinct plurality of data plane nodes; and
a processor adapted to calculate a path for a connection in response to receiving the first message and to configure the plurality of data plane nodes according to the path to establish the connection,
wherein the communications interface is further configured to send a second message to the external control plane entity over the user to network interface, the second message indicating the path for the connection, and the communications interface communicates with the external control plane entity over the user to network interface using a path computation element communication protocol.

45. (canceled)
